(19) United States
(12) Patent Application Publication
(10) Pub. No.: US 2011/0064057 A1
(43) Pub. Date: Mar. 17, 2011

(54) METHOD OF ACQUIRING BROADCAST INFORMATION

(76) Inventors: Kwang Jae Lim, Daeieon (KR); Chul Sik Yoon, Seoul (KR); Hyun Lee, Daeieon (KR)

(21) Appl. No.: 12/992,374

(22) PCT Filed: Mar. 27, 2009
(86) PCT No.: PCT/KR09/01560

§ 371 Date: Nov. 12, 2010

(51) Int. Cl. H04W 4/00; H04B 7/00

(52) U.S. Cl. 370/331; 455/507

(57) ABSTRACT

In a method of acquiring broadcast information acquisition, the terminal receives partial broadcast information from a base station, and transmits an initial access message including indication for the partial broadcast information to the base station. The terminal receives an initial access response message including broadcast information other than the partial broadcast information.

### TECHNICAL FIELD

The present invention relates to a method for acquiring broadcast information.

### BACKGROUND ART

In a communication system, for example in an orthogonal frequency division multiple access (OFDMA) system, a terminal should receive broadcast information first for initial access to the system. Therefore, the OFDMA system periodically transmits broadcast information of the system or broadcast information of a sector through a broadcast channel or a broadcast message. The broadcast channel is periodically transmitted with a fixed transmission format, and includes a frame structure and minimum information required for acquiring control information transmitted to a downlink.

A terminal should acquire complete control information and exchange a control message with a base station by using a traffic burst through a downlink and an uplink in order to promptly perform an initial access process. Therefore, the terminal must acquire information for transmitting/receiving the control message through the traffic burst for the prompt initial access. The information for transmitting/receiving the control message includes broadcast information for physical layer transmission/receiving, which includes initial random access information (e.g., ranging), uplink/downlink hybrid automatic repeat request (HARQ) information, and uplink power control information.

When a broadcast information transmission period is short, the system overhead increases. When the broadcast information transmission period is long, the terminal needs a long period of time to acquire system information and accordingly the initial access time of the terminal is increased.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a broadcast information acquisition method having an advantage of shortening an initial access time of a terminal while reducing overhead.

### Technical Solution

According to an embodiment of the present invention, a method of acquiring broadcast information in a terminal is provided. The method includes: receiving partial broadcast information from a base station; transmitting an initial access message that includes indication for the partial broadcast information which the terminal has received; and receiving an initial access response message that includes broadcast information other than the partial broadcast information from the base station.

According to another embodiment of the present invention, a method of transmitting broadcast information in a base station is provided. The method includes: transmitting partial broadcast information through a broadcast channel or a broadcast message to a terminal; receiving an initial access message that includes indication for the partial broadcast information from the terminal; and transmitting an initial access response message that includes broadcast information other than the partial broadcast information to the terminal.

According to another embodiment of the present invention, a method of acquiring broadcast information in a terminal is provided. The method includes: receiving partial broadcast information of a target base station to which a handover is to be performed from a serving base station; transmitting a handover access message that includes indication for the partial broadcast information to the target base station; and receiving an initial access response message that includes broadcast information other than the partial broadcast information from the target base station.

According to another embodiment of the present invention, a method of transmitting broadcast information in a base station is provided. The method includes: receiving a handover access message that includes indication for partial broadcast information from a terminal; and transmitting a handover access response message that includes broadcast information other than the partial broadcast information to the terminal. The partial broadcast information is broadcast information which the terminal has received from a previous serving base station before performing a handover.

### BRIEF DESCRIPTION OF DRAWINGS

FIG. 1 shows a structure of frames to which a broadcast channel and a broadcast message are allocated according to an embodiment of the present invention.

FIG. 2 shows a broadcast information acquisition method at an initial access stage according to an embodiment of the present invention.

FIG. 3 shows a broadcast information acquisition method during a handover process according to an embodiment of the present invention.

### MODE FOR THE INVENTION

In the following detailed description, only certain embodiments of the present invention have been shown and described, simply by way of illustration. As those skilled in the art would realize, the described embodiments may be modified in various different ways, all without departing from the spirit or scope of the present invention. For clarification of drawings in the present invention, parts that are not related to the description will be omitted, and the same parts will have the same reference numerals throughout the specification.

In addition, unless explicitly described to the contrary, the word “comprise” or “include” and variations such as “comprises”, “comprising”, “includes”, or “including” will be understood to imply the inclusion of stated elements but not the exclusion of any other elements.

A downlink frame allocated with a broadcast channel and a broadcast message according to an embodiment of the present invention will be described first.

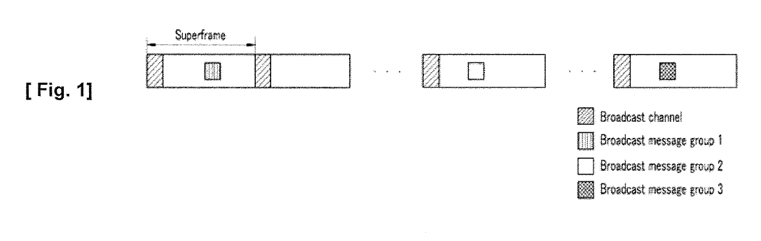

FIG. 1 shows a structure of frames to which a broadcast channel and a broadcast message are allocated according to an embodiment of the present invention.

Referring to FIG. 1, the broadcast channel is arranged in frames (or super-frames) with a relatively short period, and the broadcast message is divided into a plurality of groups and each group is arranged in the frames (or super-frames) with a different period.

Among broadcast information, information for receiving a downlink frame and information for initial random access are transmitted through the broadcast channel, and other broadcast information is transmitted through the broadcast message. The broadcast message is grouped into a plurality of groups according to contents and features of broadcast information transmitted through the corresponding broadcast message.

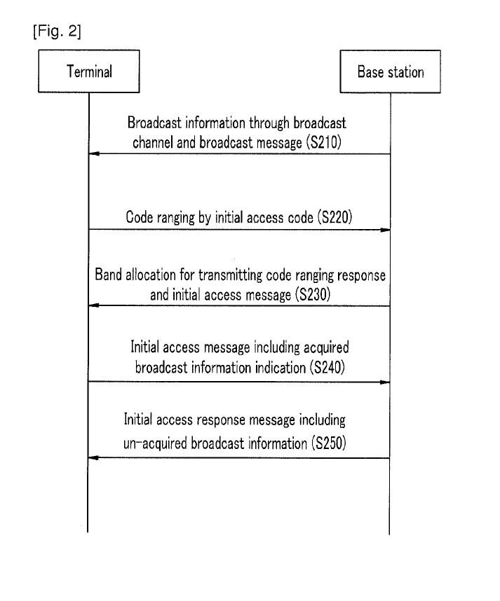

A broadcast information acquisition method in an initial access stage according to an embodiment of the present invention will be described with reference to FIG. 2.

FIG. 2 shows a broadcast information acquisition method in an initial access stage according to an embodiment of the present invention.

Referring to FIG. 2, a terminal acquires system and sector information, and information for initial random access through a broadcast channel and a broadcast message (S210), and performs a random access process. The terminal performs a code ranging process with an initial access code (S220), and then it receives a code ranging response from a base station (S230). The base station allocates uplink radio resource to the terminal so that the terminal can transmit an initial access message to the base station.

The terminal transmits the initial access message that includes indication and a version for the already acquired broadcast information to the base station (S240), and receives an initial access response message that includes broadcast information that has not been acquired by the terminal but is required for the initial access process from the base station (S250).

Such an operation may be similarly applied to a handover process. The base station broadcasts broadcast information of a neighboring base station with a relatively long period in order to reduce downlink overhead. Since the information on the neighboring base station is broadcasted with a relatively long period, a terminal that performs a handover may not receive the whole information or updated information. The terminal indicates information for a target base station which has been received from a previous base station and a version for the information in a message, for example a handover ranging request (RNG_REQ) message, which is first transmitted to the target base station during a network re-entry phase of a handover process. If there is broadcast information that is different from updated broadcast information of the target base station or broadcast information which the terminal has not received, the target base station includes the updated broadcast information or the broadcast information which the terminal has not received in a response message when transmitting the response message.

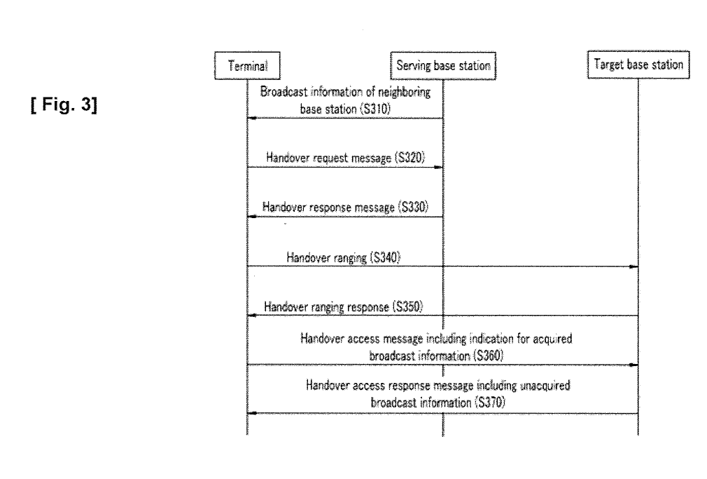

A broadcast information acquisition method in a handover process according to an embodiment of the present invention will be described with reference to FIG. 3.

FIG. 3 shows a broadcast information acquisition method in a handover process according to an embodiment of the present invention.

Referring to FIG. 3, a terminal receives the broadcast information on neighboring base stations from a serving base station (S310). The serving base station broadcasts the broadcast information on the neighboring base station with a long period in order to reduce downlink overhead. Accordingly, the terminal performing a handover process may not receive the whole information or updated broadcast information of the neighboring base station.

The terminal transmits a handover request message to the serving base station (S320), and receives a handover response message from the serving base station (S330).

In addition, the terminal transmits a handover ranging message to a target base station to which the terminal is to be handed over (S340), and receives a handover ranging response message from the target base station (S350).

After that, the terminal transmits a handover access message including indication and a version for broadcast information of the target base station, acquired from the serving base station, to the target base station (S360), and receives a handover access response message from the target base station (S370). The handover access response message includes broadcast information which the terminal could not acquire from the serving base station, and also includes updated broadcast information if broadcast information acquired from the serving base station is different from the updated broadcast information of the target base station.

As described above, according to the embodiments of the present invention, the terminal acquires minimum broadcast information in advance and acquires other information after a random access process so that an initial access time of the terminal can be shortened and overhead can be reduced.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method of acquiring broadcast information in a terminal, the method comprising:
receiving partial broadcast information from a base station;
transmitting an initial access message that includes indication for the partial broadcast information which the terminal has received; and
receiving an initial access response message that includes broadcast information other than the partial broadcast information from the base station.

2. The method of claim 1, wherein the partial broadcast information includes information for an initial random access.

3. A method of transmitting broadcast information in a base station, the method comprising:
transmitting partial broadcast information through a broadcast channel or a broadcast message to a terminal;
receiving an initial access message that includes indication for the partial broadcast information from the terminal; and
transmitting an initial access response message that includes broadcast information other than the partial broadcast information to the terminal.

4. The method of claim 3, wherein the base station transmits information for initial random access through the broadcast channel.

5. The method of claim 3, wherein the broadcast message is divided into a plurality of groups according to broadcast information to be transmitted, and each group is transmitted with a different period.

6. A method of acquiring broadcast information in a terminal, comprising:
receiving partial broadcast information of a target base station to which a handover is to be performed from a serving base station;
transmitting a handover access message that includes indication for the partial broadcast information to the target base station; and
receiving an initial access response message that includes broadcast information other than the partial broadcast information from the target base station.

7. The method of claim 6, wherein the handover access message further includes a version for the partial broadcast information, and
the handover access response message further includes broadcast information of the target base station when the partial broadcast information is different from the broadcast information of the target base station.

8. A method of transmitting broadcast information in a base station, the method comprising:
receiving a handover access message that includes indication for partial broadcast information from a terminal; and
transmitting a handover access response message that includes broadcast information other than the partial broadcast information to the terminal,
wherein the partial broadcast information is broadcast information which the terminal has received from a previous serving base station before performing a handover.
